(19) United States
(12) Patent Application Publication
(10) Pub. No.: US 2017/0243163 A1
(43) Pub. Date: Aug. 24, 2017

(54) GENERATING AND MANAGING PORTFOLIO OF ACTIVITIES ON A SOCIAL NETWORKING PLATFORM

(71) Applicant: Jagannadha Rao Vootkur, Nashua, NH (US)

(72) Inventor: Jagannadha Rao Vootkur, Nashua, NH (US)

(21) Appl. No.: 14/842,691

(22) Filed: Sep. 1, 2015

(51) Int. Cl. G06Q 10/10; G06Q 50/00

(52) U.S. Cl. CPC G06Q 10/1053; G06Q 50/01

(57) ABSTRACT

A social networking platform allows members to add portfolio objects including accomplishments and journeys. Each portfolio object may associated with a category. Based on the category, members on the platform provide structure information associated with the portfolio objects. Based on social activity on the platform around the portfolio objects, members are able to generate portfolios for activities relating to one or more categories. Portfolios may be specific to categories, sub-categories, teams, and so on. Further, the platform also allows members of the platform to connect with experts to mentor them through an event or a journey.

### TECHNICAL FIELD

The embodiments herein relate to generating and managing portfolio of curricular and extra-curricular activities based on social activity on a networking platform.

### BACKGROUND

A portfolio is a collection of accomplishments, and activities in one or more areas of interest. Portfolio is an important part of resume for any student pursuing further schooling, or any professional looking to showcase his work.

As technology is being integrated more in to daily lives, communication is happening primarily through digital media. Various communication mechanisms are prevalent today to enable collaboration and communication. With interactions between people and information exchange primarily being done digitally, all information is stored online and is available for review in future. As a result, digital portfolios are being increasingly seen as the future, to set context for a student's potential in a college application.

Due to the ease of access and communication made possible by the various platforms available today, the amount of interactions between people and exchange of information has increased tremendously. The volume of interactions that happens makes it almost impossible to keep track of and categorize the interactions. And, therefore, even though all information is recorded on the platform or platforms a member is engaging in, it can be difficult to segregate communications that relate to activities that are pertinent for a portfolio from those communications and interactions that may not be pertinent for a portfolio.

In order to solve this problem, various tools have been developed to create and manage portfolios online where members can enter information manually. While such tools provide a useful means for recording and maintaining portfolios, it becomes difficult for members to capture context of communications and activities when they log information manually. Further, members may forget some of the context or even pertinent information when they log information about an event or activity after a period of time.

In order to capture the context of a communication, it would be better to capture individual's activities and related information when the relevant activities and communications are happening.

### BRIEF DESCRIPTION OF THE FIGURES

The embodiments herein will be better understood from the following detailed description with reference to the drawings, in which:

FIG. 1 illustrates an example environment where a networking platform is deployed and accessed through network, according to an embodiment herein;

FIG. 2 shows the application components of the network platform showed in FIG. 1, according to an embodiment herein;

FIG. 3 is a flow diagram illustrating an example flow of member entering information on the networking platform, according to an embodiment herein;

FIG. 4 shows an example screen for capturing a portfolio object from the member on the networking platform, according to an embodiment herein;

FIG. 5 represents an example screen for capturing category of the portfolio object from the member on the networking platform, according to an embodiment herein;

FIG. 6 shows an example screen for capturing category related details from the member on the networking platform for an accomplishment, according to an embodiment herein;

FIG. 7 shows an example screen to capture structured information relating to a journey being tracked by the member, according to an embodiment herein;

FIG. 8 and FIG. 9 show example screens for content sharing on the networking platform, according to an embodiment herein;

FIG. 10 is an alternative flow diagram illustrating an example flow of member entering information on the networking platform, according to an embodiment herein;

FIG. 11 illustrates an example process for identifying and updating category of a post based on textual analysis using NLP, according to an embodiment herein;

FIG. 12 shows an example portfolio of a member on the networking platform with accomplishments and activities from various categories, according to an embodiment herein; and

FIG. 13 shows the detailed screen for a section from a portfolio with activities relating to a journey, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose systems and methods for generating and managing portfolio of curricular and extra-curricular activities based on social activity on a networking platform.

In a preferred embodiment, the networking platform allows members to post messages. The messages may be private messages like one to one messages, messages intended to a particular group, or messages that are public. Messages may be posted by registered members of the platform. A member may be an individual, a team, or an organization, among other possibilities.

In a preferred embodiment, the platform allows for generation of portfolios for different types of members including but not limited to individuals, and teams.

In a preferred embodiment, when a member on the platform may choose a type of post to designate such message to be included in his or his team's portfolio. For example, the platform may be configured to include all accomplishments in relevant portfolios. When a member posts a message about an accomplishment, by choosing the type of post as an “accomplishment” type. And, the platform can automatically include the message in the relevant section of the member's portfolio.

In various embodiments, an individual member can configure his profile to include certain types of activities as part of his portfolio automatically and relevant team's portfolio based on the tags associated with any given post. For example, the individual can configure his profile such that whenever an accomplishment is posted, then the platform can include the message both in the individual's portfolio and the associated team's portfolio. The post may also be included as part of his team's portfolio associated with the post as a tag. This may be useful in scenarios where the activity is a team based activity such as participation of the individual in a Soccer event as part of his team.

In a preferred embodiment, the platform allows to capture an activity to be part of a portfolio as at least an accomplishment, or an activity that is part of a journey associated with a goal event. A journey is a sequence of activities that a member or a team experiences towards a specific goal, such goal being identified by a goal event. For example, if a quiz competition is identified as a goal event which is to be organized in a future time, then all activities that are associated with the event are activities aimed towards the goal of participating in the event and probably winning a prize, and such activities form part of the journey of the individual member or the team of members having the event as the goal event.

In a preferred embodiment, the platform presents a structured template for capturing information about a planned journey with associated one or more events. For example, a journey could be related to participation in science related competitions, and multiple events associated with the journey could be the various science fair competitions like the district level science fair competition, state level science fair competition, and the final National level competition. The national level competition could be the goal event for a planned journey. In other examples, members may also use the first level competition as a goal event and capture a journey just for that one event.

In a preferred embodiment, the platform presents a structured template for capturing information about an accomplishment or a set of accomplishments. For example, an accomplishment could be related to winning a prize at a spelling bee competition. And, therefore, members will be allowed to attach such events. In other examples, accomplishments may be related to winning a team competition. In such scenarios, the platform allows members to associate teams along with events for an accomplishment.

In some embodiments, a member on the platform can configure his profile to include any endorsements associated with the member automatically in relevant portfolios. For example, an individual can configure his profile to include all endorsements related to team activity to be included as part of his portfolio and his team's portfolio. Based on such a configuration, the platform, whenever it encounters an endorsement, can include the message as part of all relevant portfolios.

In a preferred embodiment, endorsements are specifically requested by members based on their accomplishments and activities on the platform. Endorsements provided by members on the platform based on a request are automatically added to the portfolio, as a default configuration. Members can always review and edit their portfolio to include or exclude specific endorsements. In various embodiments, platform may include an endorsement as part of relevant portfolios only after the member receiving the endorsement approves the same.

In a preferred embodiment, the platform allows members to mark a message as a ‘thank’ message by way of a special tag. Such ‘thank’ messages treated equivalent to an endorsement for portfolio purposes, and are automatically added to the portfolio of the member and/or team receiving the message, as a default setting.

Further, the platform can also automatically analyze text of messages using NLP algorithms and such similar algorithms to check if the message is a praise or an endorsement, and include such messages automatically. The platform can provide an option to the members to enable and disable such a feature.

In a preferred embodiment, the platform automatically builds at least one portfolio based on the configuration provided by the member, or using a default configuration provided by the platform. In various other embodiments, a member can edit a portfolio, where the member can detach one or more activities that are part of a portfolio. Furthermore, the member can also attached one or more other activities to the portfolio.

In some embodiments, a member can create new portfolio from scratch and add existing posts, messages, and endorsements to that portfolio.

In a preferred embodiment, the platform allows a member to create multiple portfolios. For example, a member may want to create separate portfolio for curricular activities and extra-curricular activities. In another example, a member may want to present different portfolios as part of different college applications, depending on the college criteria as perceived by the member, and his accomplishments as he sees fit for those criteria.

In a preferred embodiment, the platform allows for attaching evidence information for every accomplishment and journey activity. In some embodiments, the evidence may be mandatory for certain types of activities. In some embodiments, the evidence may be optional. Evidence information may be in the form of scanned documents, digitally signed and verified documents, specifically encrypted documents with certain personal information, and so on.

In some embodiments, an organization identified as an organizer of an event, can configure the event such that evidence information is made mandatory on the platform for every accomplishment when associated with the event. The configuration can ensure that members on the platform do not post false accomplishments. The evidence so provided by a member for an accomplishment can be automatically or manually verified by the organizer.

In other embodiments, the platform allows for providing verified certificates in partnership with an organizer of an event on the platform. For example, when a member posts an accomplishment associated with an event, the organizer of the event associated with the accomplishment can automatically verify the accomplishment based on the event records, and attach a verified certificate to the member.

In a preferred embodiment, the platform allows experts to register on the platform as members. The platform can suggest experts to various members based on their profile and their activities. For example, a team working towards a science fair competition can obtain help from a parent who has had experience with participating or winning in a related science fair competition. Similarly, an individual preparing for a spelling bee competition can benefit by interacting with an English expert who has had experience with training spelling bee participants. In various embodiments, members can search for experts and send requests to experts to be their mentors through their journey.

In a preferred embodiment, the platform can also allow entities like universities, colleges, organizations, and individuals to register as part of the platform, and allow them to promote scholarships in an attempt to attract the best students. The platform can also automatically match one or more members on the platform with one or more scholarship depending on the criteria provided by the participating organizations providing scholarship, and the activities of the members and their interests.

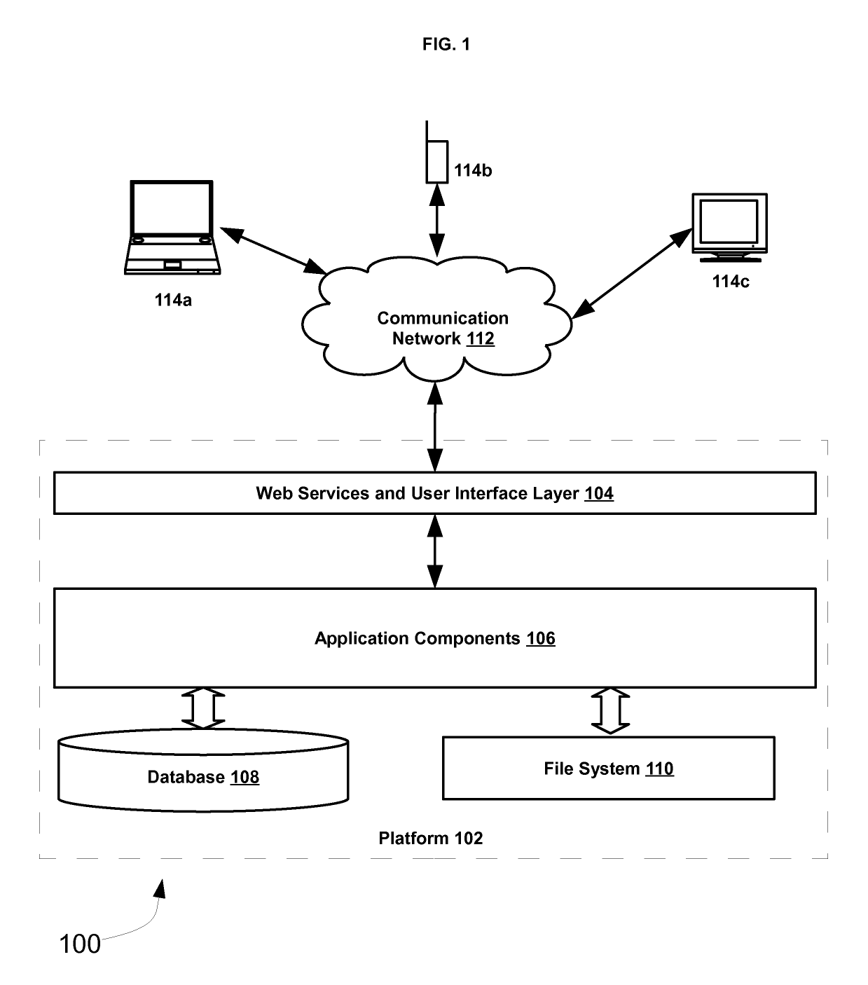

Referring now to the drawings, and more particularly to FIGS. 1 through 10, where similar reference characters denote corresponding features consistently throughout the figures, there are shown embodiments.

FIG. 1 illustrates an example environment where a networking platform 102 is deployed and accessed through network. The networking platform 102 is accessed by a plurality of members using various electronic devices 114a-c connected through a communication network 112. The platform 102 includes a web services and member interface layer 104 to provide access to the platform 102 including user interface functionalities. Further, the collaboration platform 102 includes application components 106. Furthermore, the application components 106 are connected to a database 108 and external applications through external application connectors 110.

In a preferred embodiment, the communication network 112 is a Wide Area Network (WAN) like the Internet or telecommunication networks. Access to the application components may also be enabled through other network mechanisms including but not limited to Personal Area Networks (PANs), Local Area Networks (LANs), Campus Area Networks (CANs), or Metropolitan Area Networks (MANs). The type of network employed and the reach provided depends on the type of the enterprise that is deploying the platform 102, the needs of the enterprise, and the distributed nature of the enterprise among other parameters. Therefore, in a various embodiments, the platform components may be distributed across multiple computing servers located at a single location or multiple locations.

In an embodiment, the database 108 is an internal database tightly coupled to the application components 106. In other embodiments, the database is an independent service running on a same computing machine, or a different machine being accessible over a network such as the communication network 112 or otherwise. The database may be a relational SQL database, Operational Database, text database or No-SQL database and/or combination thereof. In some embodiments database may be a single instance running on a single machine. In some other embodiments, there could be a cluster of databases running in multiple locations, each updating each other using a master-slave configuration or otherwise.

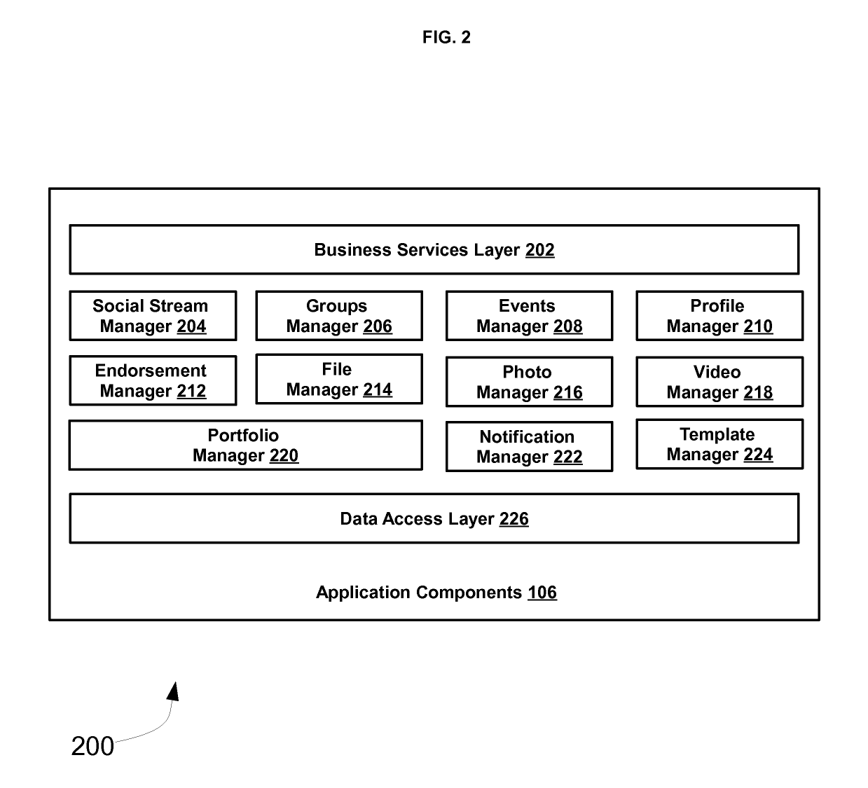

FIG. 2 shows the application components 106. The functionalities of each of the components are described herein.

The business services layer 202 exposes the functionalities of the components of the platform in the form of various APIs. In a preferred embodiment, the calls to the components of the platform 102 may be made through regular programmatic calls. In various embodiments, the functionality of the various components may also be available to remote components through web service APIs.

The data access layer 226 enables storage and retrieval of data from the database 108 and file system 110 used to stored data. The data access layer may be used any of the components to the platform 102 to access and store data to the underlying storage entities.

Social stream manager module 204 on the platform 102 allows members on the platform 102 to enter data about their accomplishments, and/or activities in the respective categories. Members may further comment and continue conversation based on activity from other members. Social stream manager module 204 also allows members to endorse other members.

Activities that are accomplishments are processed by the portfolio manager module 220 and added appropriately to one or more portfolios as applicable. Each accomplishment recorded may be associated with an event and every activity posted can be tracked against a particular example. An example of Accomplishment recorded can be participating or winning a 5 K race, a goal tracker can help track the training over a period of time.

The social stream manager module 204 manages the social stream activity on the platform 102 and ensures that social stream content is visible and accessible to the right member on the platform 102.

Social stream manager module 204 interacts with template manager module to serve appropriate template according to the type of activity, and lets a member on the platform 102 to associate an existing event or create a new event as appropriate to the activity.

Through groups manager module 206, the networking platform 102 allows members to create groups to organize and share team activities. Members of a group are allowed to create tasks and assign to members of the group. Further, a group can have events specific to the group. Groups can have goal trackers and accomplishment recorder.

The groups module 206 enables a group to engage in discussions open to the members of the group. Further, the groups module 206 also ensures that information posted in a group is only visible to members of the group only.

The portfolio manager module 220 provides functionality for creating and managing portfolios. The portfolio manager module 220 allows a member to create and manage multiple portfolios. When a member requests creation of a portfolio, based on the criteria provided by the member, the portfolio manager module 220 builds the corresponding portfolio. For example, when a member requests creation of a sports based portfolio, the portfolio manager module 220 stitches together all the accomplishments and journey activities related to one or more events into a single portfolio. In another example, the member may also request creation of a sub-category specific portfolio, like a portfolio for Soccer activities. In such a case, the portfolio manager module builds a portfolio based on accomplishments and journey activities related to the sub-category identified by the member.

In a preferred embodiment, the platform 102 may provide default templates for certain categories and sub-categories to generate portfolios. Members can also define their own templates of portfolios based on their preferences. A template definition may include but not limited to the categories and/or sub-categories to be included, the arrangement of various sections of the portfolio, and the ordering of the sections. The portfolio manager module 220 may use pre-defined or member-defined templates when generating a portfolio, based on member input. For example, a member may request generating a portfolio for a specific category. In such a scenario, the portfolio manager module 220 may use a pre-defined template available for the specific category. However, if the member has defined a template for the category and identified the template as the default for the category, then the portfolio manager module 220 can use the member-defined template. Furthermore, when a member requests generation of a portfolio, he may identify a specific template. In such a case, the portfolio generates a portfolio based on the definition of a portfolio template.

Further, the portfolio manager module 220 can build a portfolio for a group of members on the platform 102. The request to create a portfolio for a group can be given by any member authorized to be part of the group. In various embodiments, the platform 102 can provide facility to restrict ability of one or more members in a group to create group portfolio. In some embodiments, there may be members identified as administrators of the group and only they may be able to generate and manage portfolios.

The portfolio manager module 220 processes all the information posted on Social Stream, Group Stream and Event Stream so that portfolio module presents the data to member accordingly.

The portfolio manager module 220 consists of functionality to customize and share a portfolio according to the criterion selected such as dates or other criterion. For example if you would like to see how many of hours of community service you did during last 6 months and details of the same, you may create such a portfolio and further set the privacy settings such as who can view the portfolio generated. Same module also lets you add items previously marked as Activity. An item on portfolio may be associated with an Endorsement/Recommendation, like a recommendation from Lego league coach to a member for excellent contributions.

The portfolio manager module 220 further allows for editing, and removing existing portfolios for a member or a group. Members on the networking platform 102 can an edit an existing portfolio to include new accomplishments or activities. In a preferred embodiment, the platform 102 facilities automatic updating of a portfolio based on members activities on the platform 102 and based on portfolio settings automatically. A member may subsequently review and edit a portfolio to ensure that the portfolio is according to his preferences.

The events manager module 208 lets members create and share information relating to events through the social stream. An example of an event is a competition being conducted. In a preferred embodiment, event organizers create an event and share information relating to the event to other members on the platform 102.

A member or a group can join an event. Once a member or group is associated with an event, any accomplishments posted by the member or group in social stream or groups can be associated with an event that the member or group is associated with.

Furthermore, the events module 208 allows tracking of activities for a specific event.

The profile manager module 210 manages the member data such as username, password, location, profile picture, video, and associated settings. This module 210 lets the member to set the privacy settings for all the information stored and shared using Social Stream module. In a preferred embodiment, the platform 102 provides default privacy settings for posts on the platform 102. The member can also personalize the privacy settings based on his preferences. For example, the member may want to review default privacy settings for each and every post before posting content or update on the platform 102. In another example, the member can set different default privacy settings for different categories. So, for example, member can configure all sport related posts to be made public, and all other posts be made restricted to the group or individual depending on the context.

In various embodiments, the profile module 210 also allows the member to add sub-profiles. For example, sub-profiles can be profiles for specific types of activities. Sub-profiles can also be profiles of other individuals that the member can manage and administer on behalf of another individual. For example, a managed profile can be a profile of a child who may not be eligible to have a social networking account. Such managed profiles can be incubated under the profile of the member till the individual becomes eligible to have his own profile on the platform 102. The eligibility for owning a profile may be at least based on age. When a child attains the eligibility age, then a sub-profile may be converted to a full profile, and the rights may be transferred to the child to manage his own account on the platform 102.

In various embodiments, the platform 102 may track the eligibility of an incubating sub-profile to become a full profile and send alerts to the owner of the profile. In some embodiments, the platform may automatically convert 102 an incubating sub-profile to a full profile immediately upon satisfying eligibility criteria.

An endorsement is a recommendation is written or received by member of the system for an accomplishment posted using Social Stream module or using Groups Module. The endorsements manager module 212 allows for these endorsements to have privacy settings to control the visibility, and therefore, how they appear in a portfolio as generated by the portfolio module.

File manager module 214 manages the organizing the data which need to be stored on Server's file system and retrieving the same.

The photos manager module 216 allows members to create picture albums of accomplishments or activities. This module 216 allows members to organize the pictures posted in Social, Group and Event streams by a member.

The video manager module 218 allows members to create video albums of accomplishments or activities. This module allows members to organize the videos posted in Social, Group, and Event streams.

Notification Manager module 222 is responsible to send and receive various types of notifications such as a when a friend request is generated, when a message in received by a member in his social stream, when member is tagged (mentioned) by a friend who is also member on the system, system notifications to notify members on the network about general system information like maintenance downtime, and so on. In various embodiments, members can control through their preferences the types of notifications they want to receive and the types of notifications they want to suppress. The notifications module 222 presents notifications to the member according to this preferences.

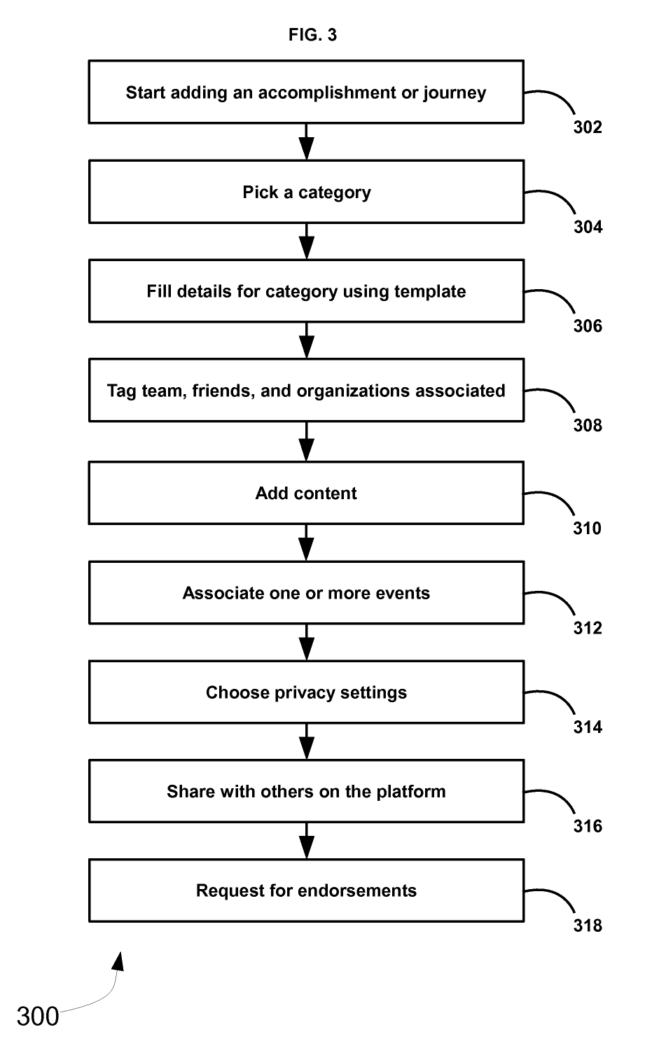

FIG. 3 is a flow diagram illustrating an example flow of member entering information on the networking platform 102, according to an embodiment herein. In the example, member begins by entering information by choosing the type of portfolio object that wants to add (302)—either an Accomplishment or a Journey. It may be evident to a person of ordinary skill in the field that the type of portfolio objects are only representative and themselves are not limiting in any way.

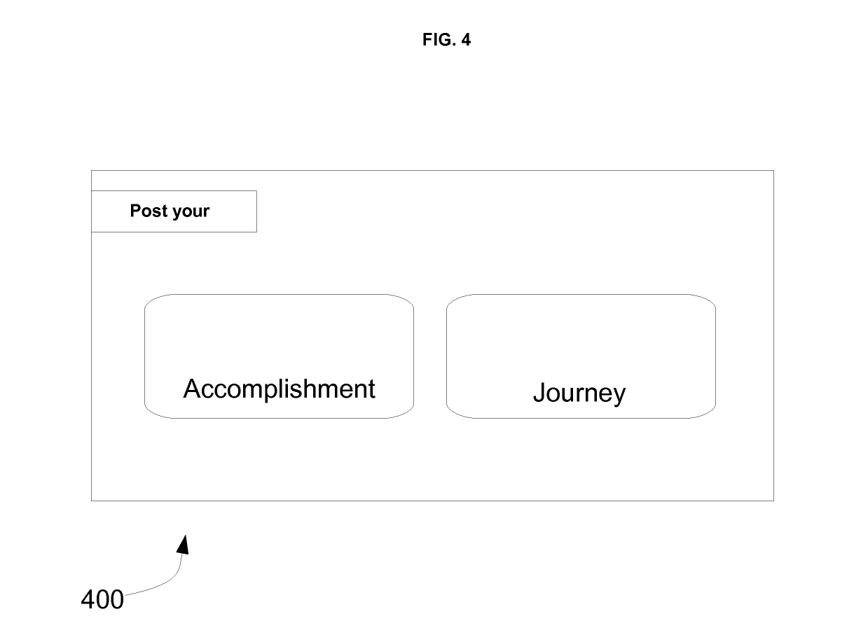

FIG. 4 shows an example screen 400 for capturing a portfolio object from the member on the networking platform 102. Accordingly, the member can either choose ‘Accomplishment’ or ‘Journey’ on the screen to proceed further.

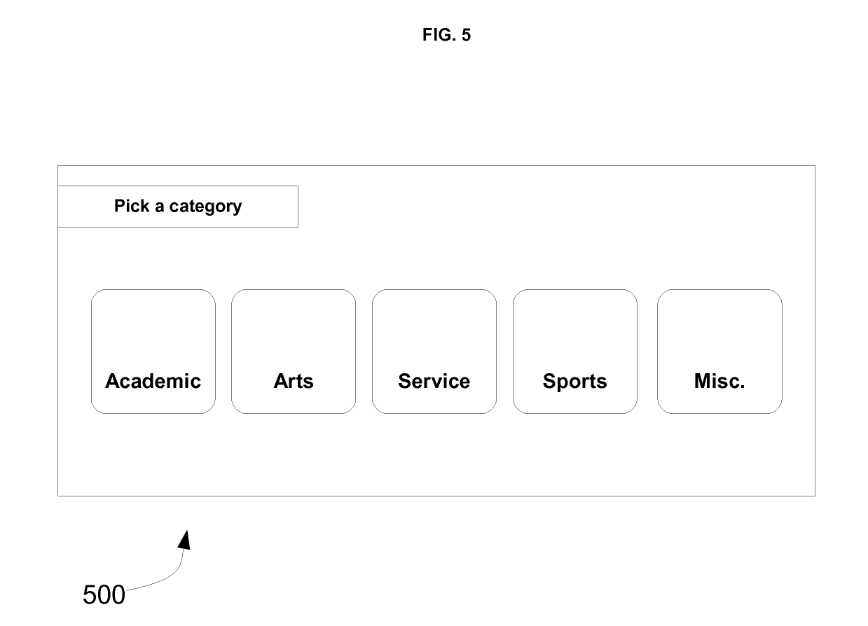

Once the type of portfolio object is selected, the platform 102 presents a list of pre-defined categories for the member to select (304), in order to categorize the information being entered. FIG. 5 represents an example screen 500 for capturing category of the portfolio object from the member on the networking platform 102. In the example 500, the categories presented include Academic, Arts, Science, Sports, and Misc (meaning, miscellaneous). It may be evident to a person of ordinary skill in the field that the categories are only representative, and themselves are not limiting in any way. For example, in some other embodiments, more refined categories (like specific sports and arts activities) may be presented. Further, in other embodiments, sub-categories may also be presented when a particular category is selected or highlighted.

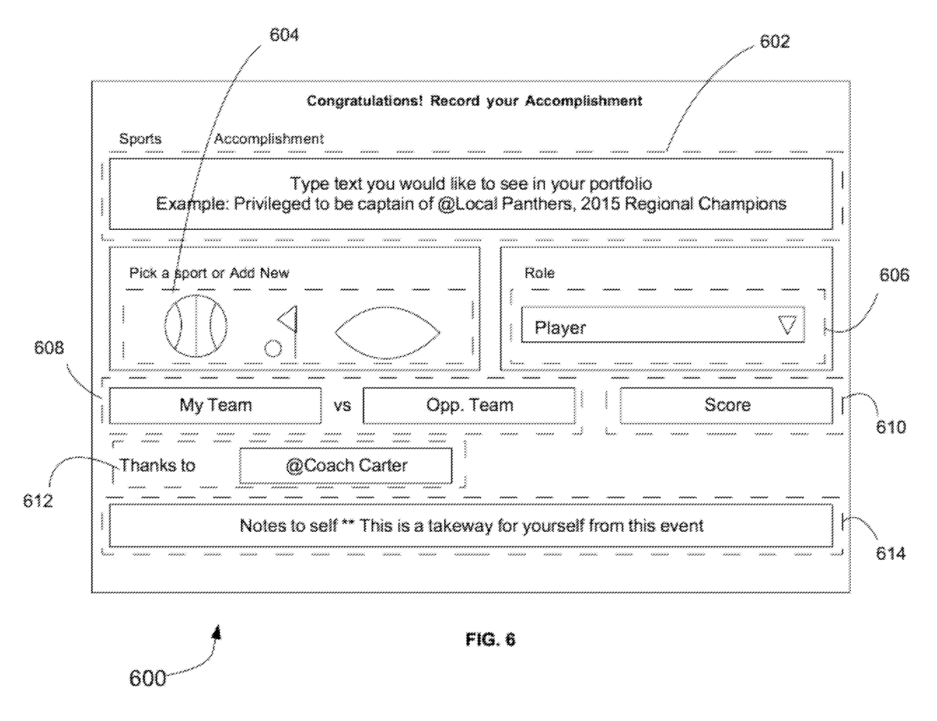

Based on the category selected, member will be presented with an appropriate template to fill relevant details, as appropriate to the category. For example, if the category ‘Sports’ is chosen, a template that captures score details, coach information and so on is presented. FIG. 6 shows an example screen 600 for capturing category related details from the member on the networking platform 102 for an accomplishment. The example screen 600 is related to sports category and captures an accomplishment by having the member fill (306) the details. Area 602 allows the member to enter text that will be part of an appropriate portfolio. Area 604 on the screen allows the member to pick a relevant sport from a pre-defined list of sports. In various embodiments, the platform 102 can allow the member to add more sports through member settings. Area 606 allows the member to choose his role in the sport. In a preferred embodiment, the roles presented can be varied depending on the sports selected by the member. Area 608 captures the teams involved in the sporting activity, especially when a team sport is selected. In a preferred embodiment, area 608 may not be presented for an individual sport or may be presented in a way to capture individual members for individual sports. Area 610 captures the score associated with the sporting accomplishment. Area 612 allows the member to thank individuals, groups, and organizations on the platform 102. In a preferred embodiment, the platform 102 may present suggestions of names of individuals, groups, and organizations as the member starts typing a name to thank. Area 614 of the screen allows the member to add additional notes for future reference.

In various embodiments, the member can also enter (308) other relevant information including associated friends, teams, organizations, and so on as part of the category template. This association may be separate from the individuals, groups or organizations that the member included to thank for their contribution and involvement. Based on such association other members on the platform 102 can view, track, and comment the information posted.

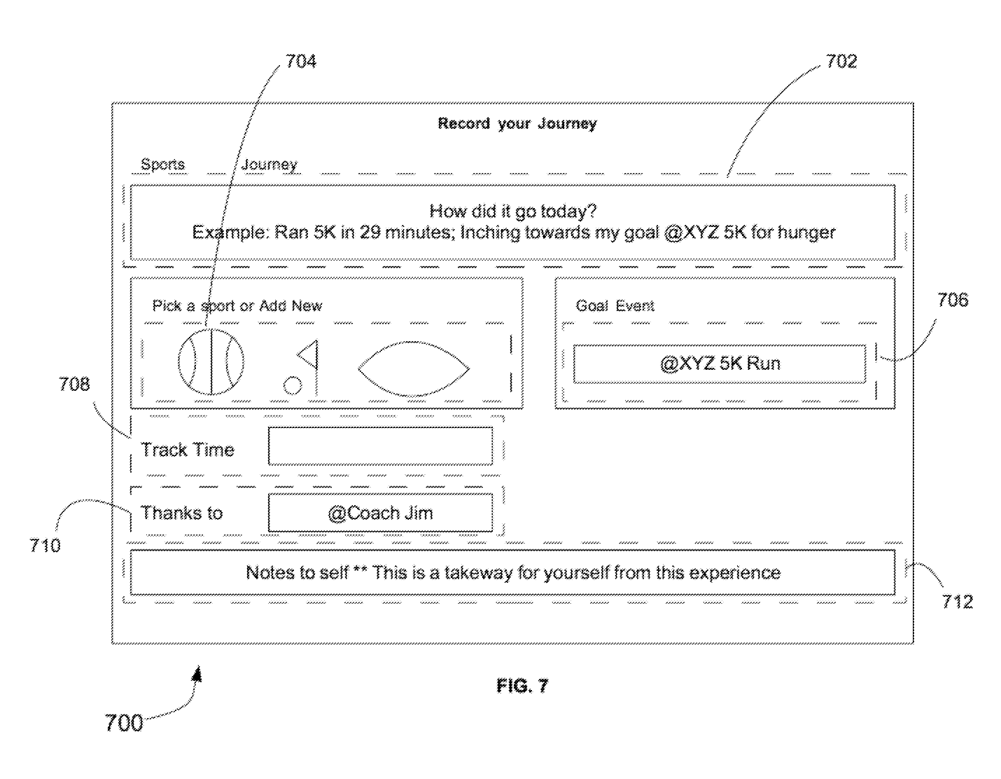

FIG. 7 shows an example screen 700 to capture structured information relating to a journey being tracked by the member. Just like example screen 600, example screen 700 is related to the category for Sports. However, example screen 700 captures information relating to a journey with a target goal event being associated with it.

Area 702 allows the member to enter text that will be part of an appropriate portfolio. Area 704 on the screen allows the member to pick a relevant sport from a pre-defined list of sports. In various embodiments, the platform 102 can allow the member to add more sports through member settings. Area 706 in screen 700 allows the member to select the goal event associated with the journey. In a preferred embodiment, based on the sport selected by the member and based on the letters typed by the member, the platform 102 may display a list of probable goal events that the member may be interested in. The member can either type in the event information or selected from the choices provided by the platform 102. If an event is not already defined on the platform 102, the member may be provided an option to enter event related information in a different screen (not shown in the figure). Depending on the sport chosen, the platform 102 may dynamically show different relevant fields to capture as part of the journey information. In this example screen 700, the sport ‘Running’ is chosen and, therefore, relevant field such as “Track Time” are shown in area 708 of the screen. The member providing the journey information may also provide a “thank” message to one or more members, teams, and organizations on the platform 102 using the “Thanks to” area 708 of the screen. Further, the member may also add additional notes for future reference using area 710 of the screen 700.

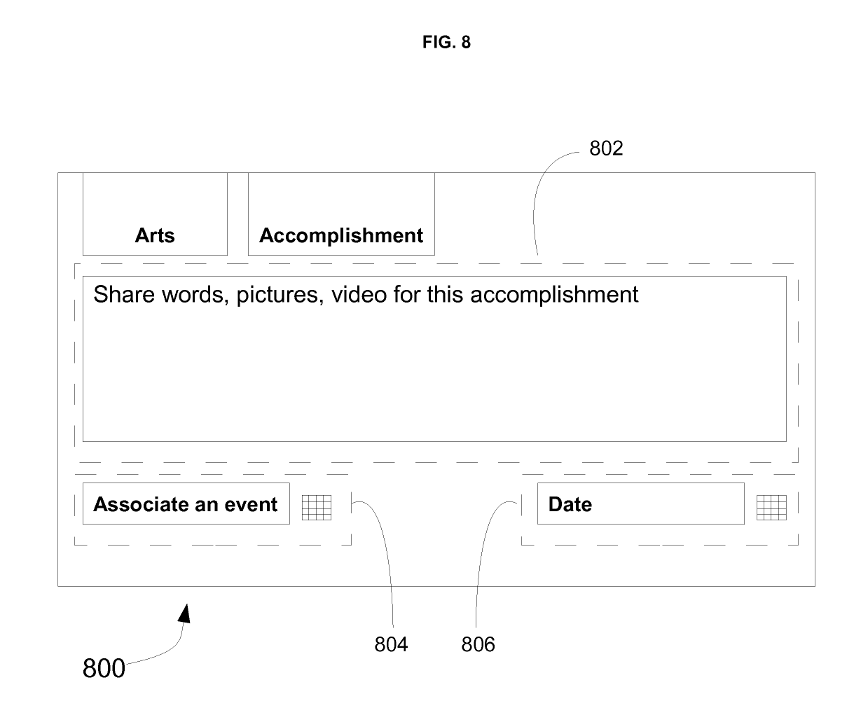

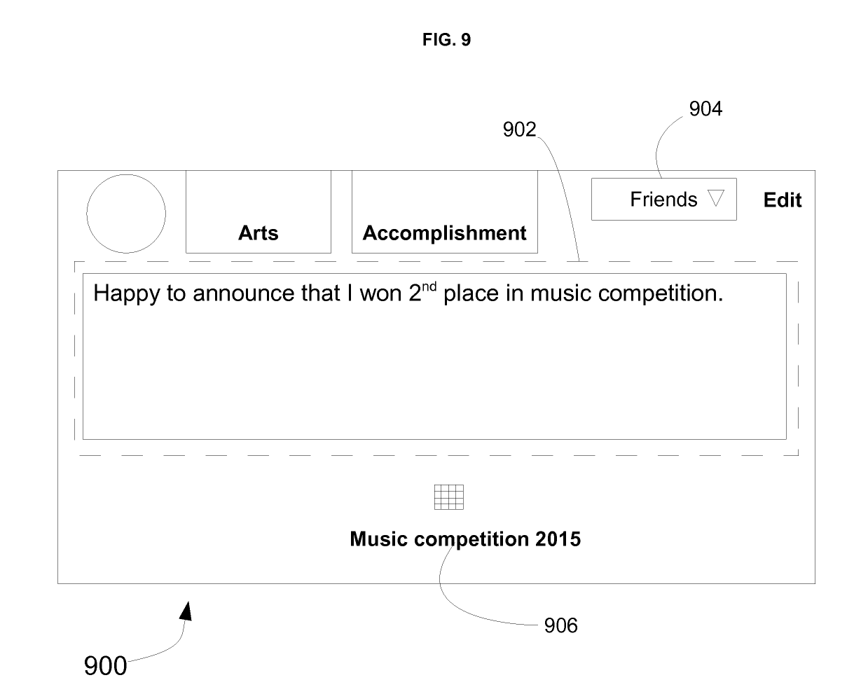

The member can then add (310) the content or message to be seen by others on the platform 102 based on the privacy settings chosen by the member. FIG. 8 and FIG. 9 show content sharing example screens 800 and 900 respectively. Using area 802, the member can provide a message or content like a video link, audio link, or link to other content like files. The content may be hosted on a public site on the Internet or on the networking platform 102. In various embodiments, a navigator (not shown in figures) can be provided for the member to choose content hosted on the networking platform 102. For example, the navigator can be used to choose one or more files uploaded by the member to the networking platform 102.

The member can also associate one or more events (312) with the template. This can be achieved by using area 804 in the example screen 800. In the case where the member is entering information relating to a Journal, the event may be a goal event that the member is working towards. For example, a goal event can be a national sports event, and the activity information that the member is entering can be relating to a practice game that the member and his team have played. Similarly, in the case where the member is entering information relating to an accomplishment, the event may be the event at which the accomplishment was achieved. For example, the member can enter the art competition as the event in which he participated and got a prize.

The member can further select a relevant date for the event using area 806.

The events being associated with the information entered into the platform 102 can pre-defined by the member or any other member on the platform 102. In various embodiments, the member can also define a new event and associate such event with the information he is entering into the platform 102.

Further, the member may choose (314) the privacy level of the information and thereby define the level of visibility of the information. This can be achieved by using area 904 of example screen 900. In an embodiment, visibility can be restricted to a specific groups, specific individuals, and specific organizations. In the example screen 900, the visibility is restricted to the group ‘Friends’. The visibility can also public or private. Public visibility means that there are no restrictions to who can view the information. And, private visibility means that only the member can view the information by him.

In one embodiment, the example screen like 900 may be presented to the member after entering the content and selecting the relevant event.

Subsequently, the member can share the information (316) with others on the platform 102 in accordance with the privacy settings chosen by the member.

The member may also choose to request endorsements (318) for the accomplishment or activity that the member entered into the platform 102. Endorsements received may be added to the portfolio of the member, depending on the settings configured by the member.

In some embodiments, the platform 102 can allow members to create and define categories in addition to the pre-defined list of categories provided by the platform 102.

The example embodiment in FIG. 3 may also be applicable to a group, where a group of team members can enter information relating to an achievement, activity associated with an event, and so on.

The various actions in method 300 may be performed in the order presented, in a different order or simultaneously. Further, in some embodiments, some actions listed in FIG. 3 may be omitted.

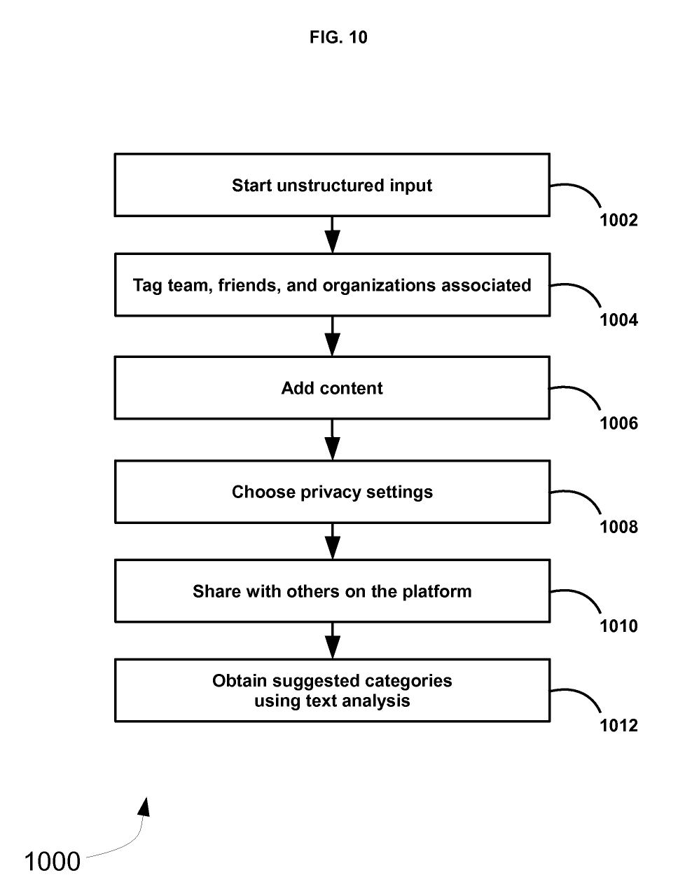

FIG. 10 is an alternative flow diagram illustrating an example flow of member entering information on the networking platform, according to an embodiment herein. The platform 102 enables members to enter unstructured input, and the platform automatically extracts relevant data and categorizes the input information as being at least an accomplishment or a journey when possible. A member on the platform 102 may start entering (1002) unstructured input by way of a post without identifying any type. Further, the member can also enter (1004) other relevant information including associated friends, teams, organizations, and so on as part of the post. This association may be separate from the individuals, groups or organizations that the member may include to thank or refer otherwise for their contribution, involvement, and so on as part of the unstructured input. The member may further add (1006) a message and additional content including files and links to images, video, and audio content on the platform or outside the platform. As with capturing structured information as illustrated by FIG. 3, member may further choose privacy settings (1008) for the post and share the post (1010) with other members on the platform.

In a preferred embodiment, the portfolio manager 220 can include a Natural Language Processing (NLP) engine to understand text messages. The unstructured input text can be passed to the NLP engine for processing and analysis. The NLP engine can process the text input and provides a probable list of categories with associated confidence or certainty levels. The portfolio manager 220 can ascertain a category to the post and subsequently include such message and related content in a relevant portfolio based on member preferences.

An example of unstructured message could be “Won 3rd place in Lego Leagues, thanks to Coach Carter! St. Louis here we come!” The message captures information regarding an accomplishment, a ‘thank’ message to a coach, a reference to a member who is a coach, an associated event, and reference to a location of a probable future event which may hint that the event referred is part of a journey. The NLP engine can extract relevant entities and relationships including but not limited to the accomplishment, associated events, associated members, member contributions, member roles, any organizations, and future target events to understand if the message is relating to a specific accomplishment and/or is part of a journey.

In a preferred embodiment, the entities universe used by the NLP engine can be finite, based on a set of entities stored in the database 108 or the file system 110. The entities universe as stored can be updated on a regular basis by the components of the platform 102, including but not limited to the events manager 208, social stream manager 204, profile manager 210, the endorsement manager 212, and the portfolio manager 220 including the NLP engine. For example, the events manager 208 can include new events registered on the platform by various members to the entities universe for use by the NLP engine.

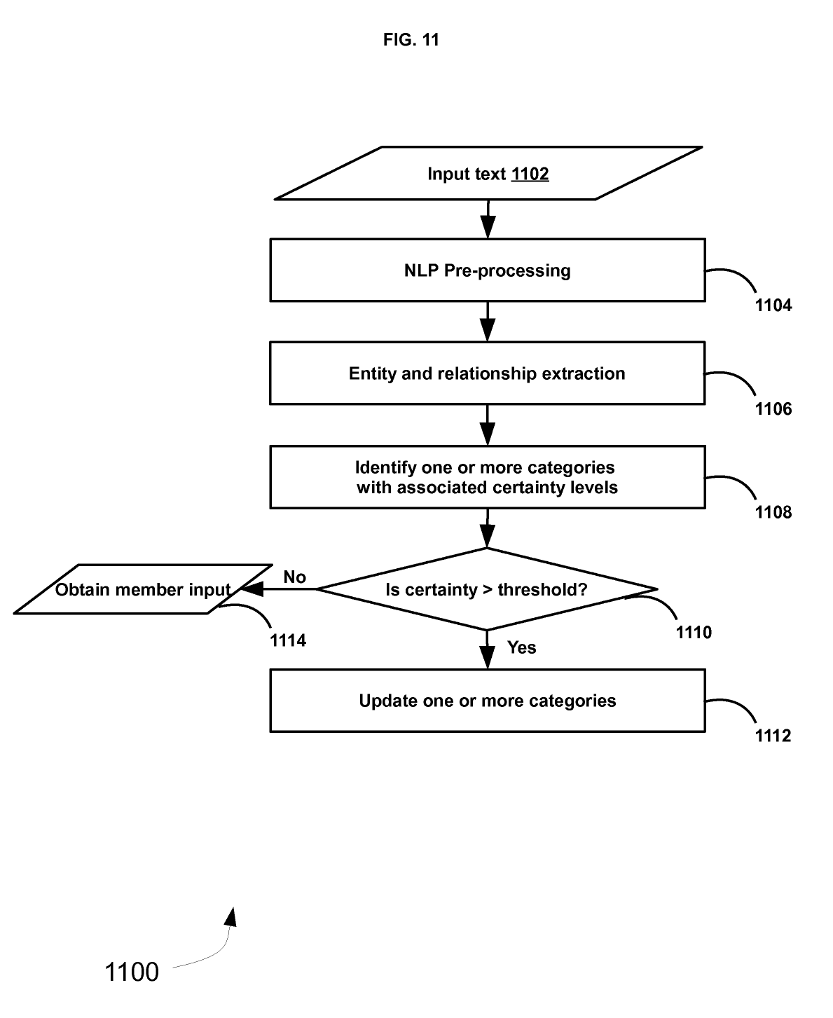

FIG. 11 illustrates an example process for identifying and updating category of a post based on textual analysis using NLP, according to an embodiment herein. When a member posts a message and shares with other members on the platform 102, the NLP engine of the platform manager 220 performs pre-processing of the input text 1102. NLP pre-processing may include tokenizing string, and/or creating a language graph using known techniques for further analysis. In a language graph, the node may represent entities and the edges may represent the relationships between the entities. Using the language graph or the tokens, the NLP engine can further extract entities and relationships. Based on the entities and relationships obtained, the NLP engine may identify (1108) one or more probable categories for the post with associated certainty levels for each probable category. The portfolio manager 220 checks the categories and associated certainty levels to ascertain the category to be used for the post. The portfolio manager can ascertain the category by checking (1110) the certainty against a predefined threshold value of certainty.

When there is at least one category with a certainty value greater than the predefined threshold value, then the portfolio manager 220 updates (1112) the post with the relevant category information. A post may have more than one category associated. For example, there can be a series of accomplishments as part of a journey. In such a case, each accomplishment qualifies both as an accomplishment and as an activity as part of a journey.

In a case where no probable category has a certainty value greater than a predefined threshold value, then the platform can request the member (1114) who created the post to add a category, if appropriate. In some embodiments, the platform can even suggest the top most category based on certainty values for the post based on probable categories determined by the NLP engine.

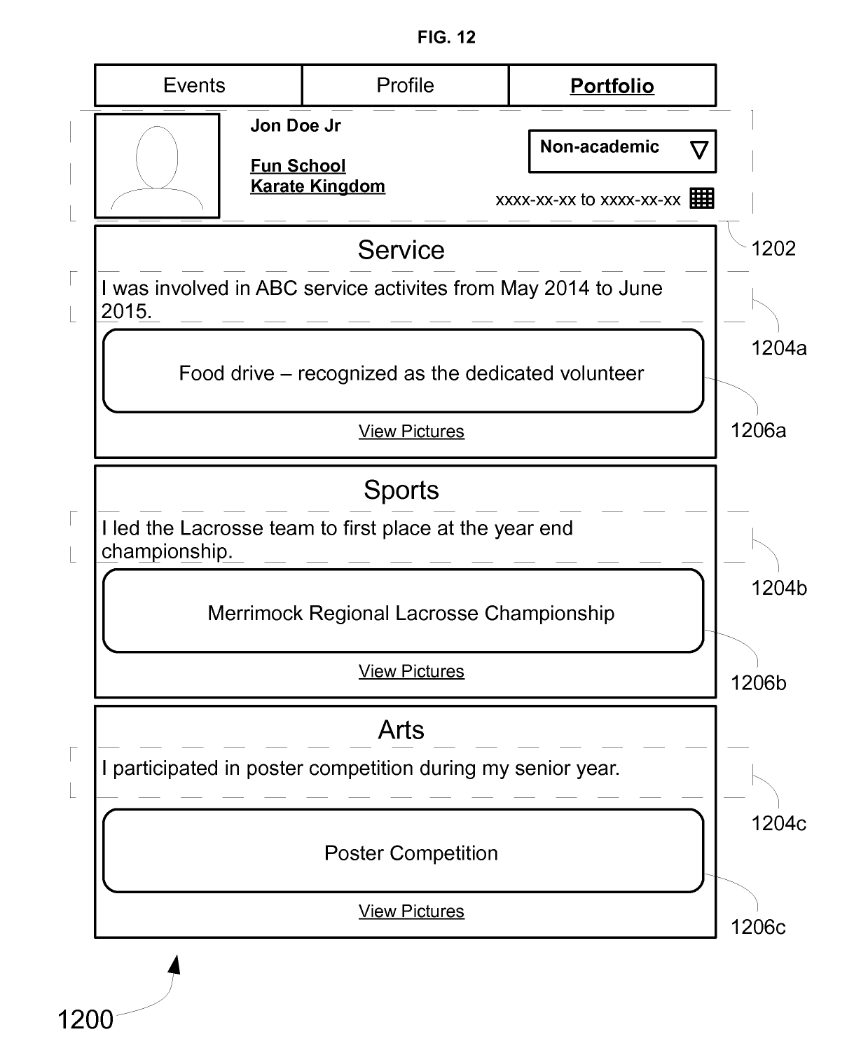

FIG. 12 shows an example portfolio 1200 of a member on the networking platform 102 with accomplishments and activities from various categories including Service, Sports, and Arts.

Area 1202 in the example portfolio 1200 provides the basic information regarding the portfolio including the member information, the affiliations of the member with institutions and organizations, teams, and so on. The area also indicates the type of information captured in the portfolio. For example, portfolio 1200 shows an example of a non-academic portfolio as indicated by the drop down as part of area 1202. The member may quickly change the sections to be included by selecting pre-selected settings. For example, the member may select “All” in the drop down, and the platform 102 will render the platform 102 with an additional academic section as well. In other examples, the member may also choose to include only one category related information in the portfolio or even only a particular sub-category. Further, area 1202 in this example also shows the dates to which the portfolio is restricted to. The member may change the dates to which the portfolio is restricted, and the platform 102 automatically renders the portfolio with relevant information based on the new dates chosen.

The example portfolio 1200 includes various sections for various categories that are captured in the portfolio. Under each category, the member can enter a summary text to summarize his activities and accomplishments for that category. The summary text at the top of each category section (1204a, 1204b, and 1204c).

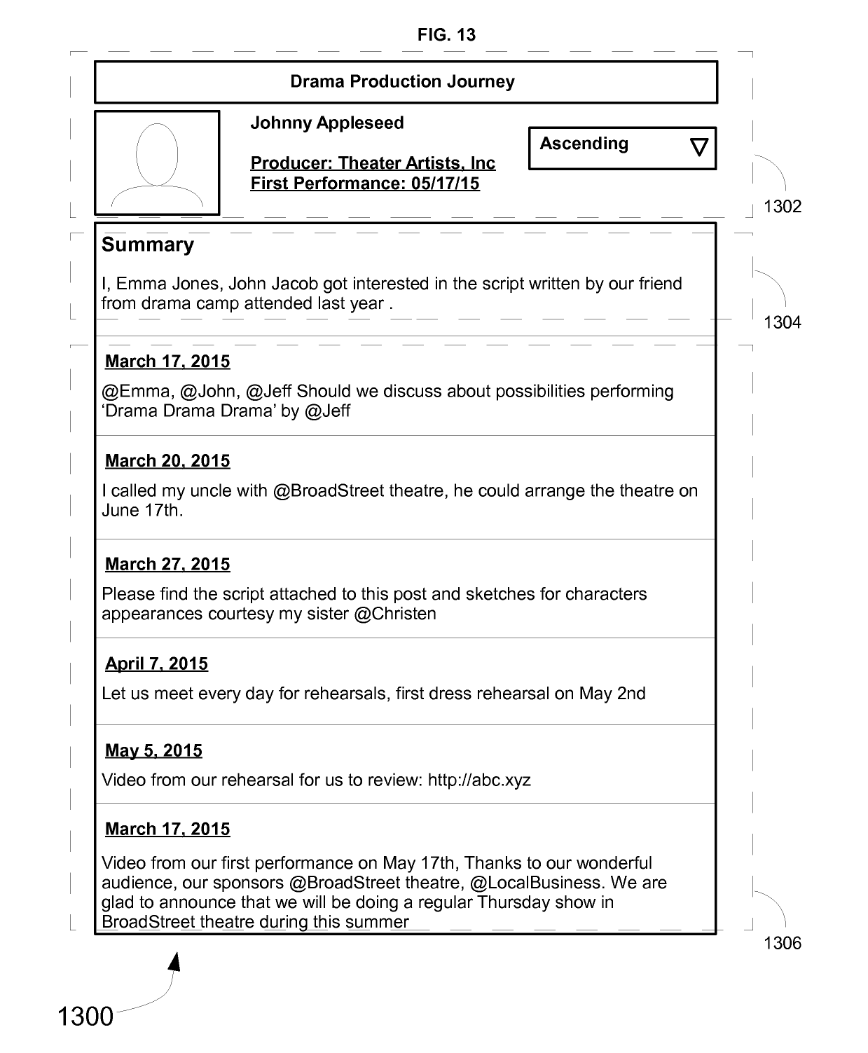

Further, each category section has one or more subsections (1206a, 1206b, and 1206c) according to the various accomplishments and activities attributed to the member either individually or as a team, based on the settings for the portfolio. The member may see further details of list of accomplishments, activities and/or endorsements under each sub-section when accessed by the member as illustrated in FIG. 13.

FIG. 13 shows the detailed screen 1300 for a section from a portfolio with activities relating to a journey for a theater performance. Area 1302 of the screen 1300 captures the basic information relating to the journey and the associated goal event. In the example screen, the member is able to view the activities either in ascending order, descending order, or any other suitable order as provided by the drop down in area 1302. When the member chooses a different view, the platform 102 renders the screen automatically to display the activities under the journey in the order of member's choice. Area 1304 of the screen 1300 shows the summary of the journey and activities associated with it, as provided by the member. Are 1306 of the screen 1300 shows the various activities including messages, shared content, comments, accomplishments, endorsements, and so on that are part of the portfolio under the relevant section.

In various embodiments, the platform allows members to perform a variety of actions on their portfolios including but not limited to printing, sharing for peer review or general viewing or editing, submitting to an organization such as a University or a company for scholarship or admission requirements, and so on.

In various embodiments, the platform also allows the members to maintain multiple version of a portfolio based on edits. For example, when a member chooses to share one or more his portfolios to another reviewing member on the platform for sharing, the version with edits from the reviewing member can be stored as a new version in order not to disturb or lose the original version of the portfolio. Further, a member may also be able to add additional description information for each version so as to remember the reason for the creation of the version.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for generating and managing portfolios based on social activity on a networking platform 102. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The hardware device can be any suitable device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A computerized-method of building and generating a portfolio of activities for a member from a social network system, said method comprising:
receiving at least one request to add a portfolio object from said member, said portfolio object being one among an accomplishment and a journey;
associating a category to said portfolio object as chosen by said member;
presenting a structured template specific to said category to said member to capture information about said portfolio object;
receiving information on plurality of activities associated with portfolio objects based on input from one or more members on said social network system;
receiving a request to generate portfolio of activities associated with said member; and
generating a portfolio of activities for said member from said host social network system, according to said request.

2. The method in claim 1, wherein said request to generate a portfolio is limited to a list of identified categories.

3. The method in claim 1, wherein said request to generate a portfolio is limited to a specific category.

4. The method in claim 1, wherein said request to generate a portfolio is limited to a specific sub-category.

5. The method in claim 1, wherein said request to generate a portfolio is limited to activities relating to a team.

6. The method in claim 1, wherein an activity from said plurality of activities is one among
participation by said one or more members,
accolade received by said one or more members, and
accomplishment of said one or more members.

7. The method in claim 1, wherein an accomplishment portfolio object includes related evidence information.

8. The method in claim 1, said method further comprising:
receiving information about one or more events associated with said portfolio object.

9. The method in claim 8, wherein said event information for an event from said one or more associated events includes at least one among:
one or more teams associated with said event;
one or more tags associated with said event;
one or more friends on said social network system associated with said event;
one or more roles of said one or more members in said event;
privacy information;
one or more endorsements to said one or more members related to said event; and
one or more endorsements to said event.

10. The method in claim 1, said method further comprising
receiving information on entities to share an event from said one or more events, said entities including at least one among one or more members, one or more teams, one or more groups, and one or more organizations; and
providing access for said event to said entities.

11. The method in claim 1, said method further comprising:
receiving information about at least one goal event associated with said portfolio object, when the portfolio is a journey.

12. The method in claim 1, said method further comprising
receiving a request invite an expert on said social network system to be a mentor for an event from said one or more events;
presenting said request to said expert; and
associating said expert as a mentor to said event after approval from said expert.

13. The method in claim 1, wherein an expert is one among
a member on said social network system; and
an organization on said social network system.

14. The method in claim 1, said method further comprising
suggesting a list of experts available as mentors for an event from said one or more events;
receiving a request to invite one or more experts from said list of experts to be a mentor for said event;
presenting said request to said one or more experts invited; and
associating an expert to said event who accepts an invite received based on said request.

15. The method in claim 1, said method further comprising including all accomplishments as part of said portfolio, according to said request.

16. The method in claim 1, said method further comprising including all endorsements as part of said portfolio, according to said request.

17. The method in claim 1, said method further comprising including all journeys as part of said portfolio, according to said request.

18. The method in claim 1, said method further comprising
receiving information on at least one sub-category to be associated with an event from said one or more events; and
associating said at least one sub-category to said event.

19. The method in claim 1, said method further comprising
receiving information on at least one tag to be associated with an event from said one or more events; and
associating said at least one tag to said event.

20. The method in claim 1, wherein said activity information includes:
post information; and
at least one among
one or more tags associated with said activity;
one or more friends associated with said activity; and
one or more teams associated with said activity.

21. The method in claim 1, wherein said category is one among education, sports, arts, service and ideas.

22. The method in claim 1, wherein said member is an individual member.

23. The method in claim 22, wherein said portfolio is a portfolio of said individual member.

24. The method in claim 1, wherein said member is a group representing a team on said network.

25. The method in claim 24, wherein said portfolio is a portfolio of said team.

26. The method in claim 1, said method further comprising:
automatically generating certificate associated with an event from said one or more events for said one or more member, based on input from an organizer of said event; and
including said certificate in said portfolio.

27. A social network system for building and generating a portfolio of activities for a member, said system comprising:
a user interface module for at least:
receiving at least one request to add a portfolio object from said member, said portfolio object being one among an accomplishment and a journey;
receiving information on plurality of activities associated with portfolio objects based on input from one or more members on said social network system;
presenting a structured template specific to said category to said member to capture information about said portfolio object; and
receiving a request to generate portfolio of activities associated with said member;
a portfolio module for at least:
associating a category to said portfolio object as chosen by said member;
generating a portfolio of activities for said member from said host social network system, according to said request.

28. The system in claim 27, wherein an activity from said plurality of activities is one among
participation by said one or more members,
accolade received by said one or more members, and
accomplishment of said one or more members.

29. The system in claim 27, wherein an accomplishment portfolio object includes related evidence information.
